(19) United States
(12) Patent Application Publication
(10) Pub. No.: US 2014/0280891 A1
(43) Pub. Date: Sep. 18, 2014

(54) DETERMINING AUDIENCE REACH FOR INTERNET MEDIA

(71) Applicant: Peter Campbell Doe, Ridgewood, NJ (US)

(72) Inventor: Peter Campbell Doe, Ridgewood, NJ (US)

(21) Appl. No.: 13/837,436

(22) Filed: Mar. 15, 2013

(51) Int. Cl. H04L 12/26

(52) U.S. Cl. CPC H04L 43/08
USPC 709/224

(57) ABSTRACT

A disclosed example involves accessing an initial average unique web browser reach corresponding to a first duration, an initial average internet media impressions-per-user frequency corresponding to the first duration, an initial average unique web browser reach corresponding to a second duration, and an initial average internet media impressions-per-user frequency corresponding to the second duration. A probability model is used to determine an adjusted internet media audience reach corresponding to the first duration based on the initial average unique web browser reach corresponding to the first duration, the initial average internet media impressions-per-user frequency corresponding to the first duration, the initial average unique web browser reach corresponding to the second duration, and the initial average impressions-per-user frequency corresponding to the second duration. The adjusted internet media audience reach corresponding to the first duration has less audience duplication than the initial average unique web browser reach corresponding to the first duration.

### FIELD OF THE DISCLOSURE

The present disclosure relates generally to monitoring media and, more particularly, to determining audience reach for internet media.

### BACKGROUND

Advertisers, retail establishments, product manufacturers, service providers, and other types of businesses or entities are often interested in consumer exposure to online internet media such as websites, entertainment media, advertising and/or other informational media to better market their products and/or services.

Techniques for monitoring user access to internet resources such as web pages, advertisements and/or other online internet media have evolved significantly over the years. Some known systems perform such monitoring primarily through server logs. In particular, entities serving content on the Internet can use known techniques to log the number of requests received for their internet media at their server.

### BRIEF DESCRIPTION OF THE DRAWINGS

FIG. 1 depicts an example system to suppress audience duplication in internet media audience reach measures.

FIG. 2 depicts an example audience duplication suppressor to suppress audience duplication in internet media audience reach measures.

FIG. 3 is a flow diagram representative of example machine readable instructions that may be executed to determine the internet media audience reach having suppressed audience duplication of FIGS. 1 and 2.

FIG. 4 is a flow diagram representative of example machine readable instructions that may be executed to determine unique web browser reach using cookie deletion rates and a probability model.

FIG. 5 is a block diagram illustrating an example processor system that can be used to execute the example instructions of FIG. 3 and/or FIG. 4 to implement the example audience duplication suppressor of FIG. 1 and/or FIG. 2.

### DETAILED DESCRIPTION

Example methods, apparatus, and articles of manufacture disclosed herein enable determining audience reach for internet media. Examples disclosed herein determine audience reach for internet media by suppressing audience duplication in server-collected internet media impressions. Examples disclosed herein may analyze audience reach for internet media delivered via personal computers and/or mobile devices such as mobile phones, smart phones, tablet devices (e.g., an Apple iPad), multi-media phones, etc. Examples disclosed herein may be used to provide media providers (e.g., media publishers, media producers, advertisers, manufacturers, etc.) with internet media exposure information to enable such media providers to make more informed decisions about creating web pages, creating media programming lineups, spending advertising dollars, and/or how to distribute media. Such examples are beneficial to marketers, product manufacturers, service companies, advertisers, and/or any other individual or entity that publishes media and/or pays for media exposure opportunities (e.g., advertising exposure opportunities). In addition, consumers benefit from more efficient advertising (e.g., ads more relevant to the consumer interests) and programming that advertisements sponsor.

Examples disclosed herein enable suppressing (e.g., reducing or eliminating) audience duplication effects in internet media audience reach. As used herein, reach is a measure indicative of unique audience (e.g., based on audience members distinguishable from one another) of media. That is, one or more impressions of particular internet media that are attributable to a particular audience member is/are measured as a single unique audience member for purposes of reach. If that particular audience member is exposed multiple times to the same internet media, for purposes of reach as used herein, the multiple exposures for the particular audience member to the same internet media is still counted as only a single unique audience member. In this manner, impression performance for particular internet media is not disproportionately represented when a small subset of one or more audience members is exposed to the same internet media an excessively large number of times while a larger part of the audience member group is exposed fewer times or not at all to that same internet media. By tracking unique audience exposure, measures of reach are used to identify how many unique audience members are reached by different internet media. Increasing reach is useful for media providers wishing to reach a larger audience base.

Audience duplication occurs when a single unique audience member exposed to particular media multiple times is counted as two or more unique audience members (e.g., two or more media impressions are logged). Some prior systems decrease or eliminate the effects of audience duplication by recruiting audience members to be part of an online audience member panel by consenting to having their online activities monitored. Some prior systems maintain an online panel database to store panel member information such as demographics, media preferences, and/or other personal or non-personal information suitable for describing characteristics, preferences, locations, etc. of audience members exposed to online media. To measure impressions of internet media (e.g., web pages, advertisements, streaming radio and/or streaming video, pictures, downloadable video, streaming/downloadable music, etc.), an online measurement entity may install personal computer (PC) meters (sometimes referred to as on device meters (ODM)) at computers of audience members in the online panel to monitor the viewing habits of the online audience members. In this manner, the online measurement entity uses internet usage activity data collected by the PC meters to log impressions against different internet media to which the audience members were exposed. In such prior systems, each PC meter is provided with a unique meter ID that can be used to identify an online audience member panelist and/or an online panel household. In such prior systems, the data collection processes in the PC meters can be configured to avoid logging duplicate impressions for unique audience members or can be configured to flag duplicate logged impressions for unique audience members. Based on the PC meter-collected data, the an online measurement entity can extrapolate internet media impression data collected from the online audience member panel to a larger general audience (e.g., a population of a state, country or other geographic region of interest). However, this approach requires the online measurement entity to recruit, train, and maintain a panel, which can be very costly.

In some prior systems, instead of or in addition to using panels, internet media audience reach is determined based on data collected using online media tagging techniques to track internet media impressions. Such online media tagging techniques use media tags or advertisement tags, which are beacon instructions located in media (e.g., content or advertisements) downloaded to web browsers of client devices (e.g., computers or other internet-connected devices). In some examples, media publishers, content providers, and/or audience measurement entities (e.g., The Nielsen Company) encode beacon instructions into internet-accessible media (e.g., video, audio, advertisements, websites, etc.). When web browsers execute the beacon instructions, the web browsers send a beacon request to an online measurement entity to log an impression for the corresponding internet media. Examples that may be used to implement online media tagging techniques are disclosed in Blumenau, U.S. Pat. No. 6,108,637, which is hereby incorporated herein by reference in its entirety, and in international patent application no. PCT/US11/52623, filed on Sep. 21, 2011, which is hereby incorporated herein by reference in its entirety.

Beacon requests of the online media tagging techniques include a unique identifier such as a cookie identifier associated with the web browser on the computer. In this manner, a data collection database collects data by logging internet media impressions corresponding to unique web browsers. In some instances, users or computers delete web browser cookies. In a single computer in which such cookies are deleted, this results in a beacon request reporting an internet media impression corresponding to a different cookie identifier when the different cookie identifier is set in the computer as a result of the previous cookie deletion. When the data collection database receives the different cookie identifier in a beacon request, the data collection database logs the different cookie identifier along with the internet media impression. The different cookie identifier is assumed to correspond to a unique web browser, thus, increasing an internet audience reach measure based on the additional unique web browser. As such, when cookies are deleted in a web browser, a single web browser can report multiple different cookie identifiers that are repeatedly set in the web browser based on deletions of previous cookies. In such examples, different unique cookie identifiers logged in the data collection database may actually correspond to the same web browser but are interpreted as different unique web browsers and, thus, create audience duplications in audience reach in the data collection database. That is, because each unique cookie identifier logged in the data collection database is interpreted as representing a different web browser, it is, in turn, interpreted as corresponding to a unique person. Therefore, multiple unique users are assumed in a data collection database for multiple unique cookie identifiers associated with different logged impressions even though the multiple unique cookie identifiers were reported by the same web browser, and thus, correspond to the same person. Cookie deletions lead to double counting of a machine and, by inference, double counting an individual person as two or more unique persons. Therefore, cookie deletions are a source of error in internet media impression measurements, resulting in an overstatement of unique internet activity (e.g., internet media audience reach).

In some prior systems, overstatements of internet media audience reach measured using online media tagging techniques are addressed using sample survey research and/or the panel-based techniques described above. For example, survey or panel research is sometimes used where internet activity is directly measured, for example, by using electronic measurement of web activity using the above-described PC meters, or by relying on respondents' recall of web activity in responses to survey questionnaires. These or other measurements may also be designed to estimate cookie deletion. Measurements of activity and/or cookie deletion may then be used in conjunction with server-collected data (e.g., using the above-described online media tagging techniques) to deliver a hybrid server/sample based estimate of unique internet activity (e.g., internet media audience reach).

The use of survey-based information or panel data to adjust server-collected data has several drawbacks associated with cost, validity and reliability. An example drawback from a cost perspective is that whichever method is used, there will be some cost in creating the research (e.g., cost to recruit, train, and maintain panel members, cost to create and conduct surveys, etc.). Cost is usually directly related to the quality of the research. Another example drawback is that the results from a survey-based approach and/or a panel-based approach may exhibit errors in sample coverage, representation and/or measurement, or suffer from a lack of timeliness of reporting.

Quantitative research makes compromises between cost, reliability and validity. To increase reliability of quality measurement techniques, expenses are also increased. However, concerns over increasing cost may lead to selecting smaller sample sizes and, thus, may lead to the counter-productive effect of decreasing statistical reliability. For small websites this can lead to large relative error. For example, even with a relatively large sample size of 10,000 users, a website with 0.1% reach has a margin of error of 32% at the 95% level of confidence. In addition, the overall error may be much larger than this if there are sample representation problems or measurement problems.

Examples disclosed herein use a server-side-only approach to reduce or eliminate audience duplication in internet media audience reach. That is, examples disclosed herein determine internet media audience impression reach with suppressed duplication based on server-collected data of impressions logged using online media tagging techniques without using external panel data and/or survey data. Examples disclosed herein statistically analyze server-side-collected data (e.g., ODM-collected data) using a probability model to estimate a cookie deletion rate, and use the cookie deletion rate to determine internet media audience reach with suppressed audience duplication. Examples disclosed herein avoid the need for additional costly research related to collecting external panel data and/or survey data.

FIG. 1 depicts an example system 100 to suppress audience duplication in internet media audience reach measures. The example system 100 includes an audience duplication suppressor 102 that processes server-collected internet media impressions having audience duplication to determine adjusted internet media reach with suppressed audience duplication (e.g., reduced or eliminated audience duplication). In the illustrated example, a server-collected impressions database 104 receives beacon requests (e.g., reported internet media impressions) from client computers 106 and logs internet media impressions using online media tagging techniques as described above. The server-collected impressions database 104 may be maintained by any entity that desires to track internet media impression activities. In the illustrated example, the internet media impressions logged in the server-collected impressions database 104 include audience duplication resulting from deletions of web browser cookies at the client computers 106 as discussed in detail below.

The audience duplication suppressor 102 processes the server-collected internet media impressions from the server-collected impressions database 104 to suppress audience duplication in internet media audience reach measures without using additional costly research data collected from panels and/or surveys. The audience duplication suppressor 102 stores the internet media audience reach with suppressed audience duplication in an adjusted reach database 108.

In the illustrated example of FIG. 1, each of the client computers 106 presents internet media (e.g., a website, an advertisement, audio, video, etc.), and sends beacon requests (e.g., internet media impression reportings) to the server-collected internet media impressions database 104 whenever the client computer 106 presents tagged internet media. In the illustrated example, the beacon requests include a web browser cookie identifier of the client computer 106, a uniform resource locator (URL) of the website containing the tagged internet media, a media identifier (e.g., a media ID, an advertisement campaign ID) of the tagged internet media, and a timestamp of the impression. In this manner, the impression data collected by the server-collected internet media impressions database 104 can be used to track reach and frequency for websites and/or media presented via websites. In other examples, less or more information about reported impressions can be included in beacon requests.

Web browser cookie identifiers are set in web browsers by different internet domains that track information relevant to a user of the web browser. Such information may be related to user preferences (e.g., font, content to be presented on a website of that internet domain, etc.). In compliance with Internet policies, web browser cookies are domain specific, meaning that a web browser cookie set in a client computer 106 is only accessible to the internet domain that set the cookie. For example, a web browser cookie set on a client computer 106 by the internet domain NYTimes.com is not accessible to the internet domain Nielsen.com. Thus, NYTimes.com sets its own web browser cookie in a client computer 106, and Nielsen.com sets its own separate web browser cookie in the client computer 106. In this manner, the NYTimes.com internet domain can track information related to a web browser on the client computer 106 based on its cookie set in the web browser, and the Nielsen.com internet domain can track information related to the web browser on the client computer 106 based on its cookie set in the web browser.

In examples disclosed herein, a unique cookie identifier represents a unique web browser, and a unique web browser represents a unique person. That is, in examples disclosed herein, it is assumed that a unique web browser cookie identifier is a proxy or surrogate for a unique person. Thus, each unique cookie identifier logged in the server-collected internet media impressions database 104 is interpreted as representing a different unique person. For example, impressions logged in the server-collected internet media impressions database 104 in association with cookie identifiers C1 and C2 are interpreted as impressions corresponding to two different people, one of which corresponds to cookie identifier C1 and another one of which corresponds to cookie identifier C2.

In some instances, web browser cookie identifiers at one or more of the client computers 106 may be deleted (e.g., by a user or by that client computer 106). In such instances, whenever a cookie identifier for a particular internet domain is deleted at a client computer 106, that internet domain (e.g., NYTimes.com, Nielsen.com, etc.) sets a new cookie identifier in that client computer 106 the next time a web browser of the client computer 106 presents internet media (e.g., a website, an advertisement, audio, video, etc.) retrieved from that internet domain and/or sends a GET or HTTP (hypertext transfer protocol) request to that internet domain. The new cookie identifier is different from the previous deleted cookie identifier. In such instances, any impressions logged at the server-collected internet media impressions database 104 for the previous deleted cookie identifier and for the newly set cookie identifier will lead to audience duplication in the impressions data stored in the server-collected internet media impressions database 104. Such audience duplication occurs because although a client computer 106 is likely used by the same person, internet media impressions logged at the impressions database 104 for the previous deleted cookie identifier and the newly set cookie identifier of the same client computer 106 will be interpreted as corresponding to two different unique people. Such audience duplication results in overestimating audience member reach, because reach is a measure of a unique audience (e.g., based on audience members distinguishable from one another).

To reduce the effects of audience duplication (e.g., suppress, decrease or eliminate the effects of audience duplication) from the impression data stored in the server-collected internet media impressions database 104, the disclosed example audience duplication suppressor 102 processes the impression data to determine adjusted internet media audience reach having suppressed audience duplication. In the illustrated example of FIG. 1, the duplication suppressor 102 stores the adjusted internet media audience reach with suppressed audience duplication in the adjusted reach database 108. In some examples, the reach measures stored in the adjusted reach database 108 can correspond to different durations (e.g., daily reach, weekly reach, monthly reach, etc.) and can correspond to one or more different internet media (e.g., one or more websites, any media delivered for a particular website domain, one or more advertisements corresponding to the same advertisement campaign, etc.). In the illustrated example, the audience duplication suppressor 102 generates the adjusted internet media audience reach measures with suppressed duplication based on server-only data (e.g., using only impression data collected by the server-collected internet media impressions database 104) without relying on additional research related to collecting external panel data and/or survey data.

FIG. 2 depicts the example audience duplication suppressor 102 of FIG. 1 to determine the adjusted internet media audience reach having suppressed audience duplication of the adjusted reach database 108 of FIG. 1. The audience duplication suppressor 102 (e.g., an apparatus) of the illustrated example includes an example probability model 202, an example rate determiner 204, and an example adjuster 206. While an example manner of implementing the audience duplication suppressor 102 of FIG. 1 is illustrated in FIG. 2, one or more of the elements, processes and/or devices illustrated in FIG. 2 may be combined, divided, re-arranged, omitted, eliminated and/or implemented in any other way. Further, the example probability model 202, the example rate determiner 204, the example adjuster 206 and/or, more generally, the example audience duplication suppressor 102 of FIGS. 1 and 2 may be implemented by hardware, software, firmware and/or any combination of hardware, software and/or firmware. Thus, for example, any of the example probability model 202, the example rate determiner 204, the example adjuster 206 and/or, more generally, the example audience duplication suppressor 102 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example probability model 202, the example rate determiner 204, and/or the example adjuster 206 are hereby expressly defined to include a tangible computer readable storage device or storage disc such as a memory, a DVD, a CD, a Blu-ray disk, etc. storing the software and/or firmware. Further still, the example audience duplication suppressor 102 of FIGS. 1 and 2 may include one or more elements, processes and/or devices in addition to, or instead of, those illustrated in FIG. 2, and/or may include more than one of any or all of the illustrated elements, processes and devices.

The example audience duplication suppressor 102 is provided with the example probability model 202 to estimate repetitions in data sets (e.g., audience duplications in the impression data stored in the server-collected internet media impressions database 104). The probability model 202 of the illustrated example is implemented using a Gamma Poisson model. However, the example probability model 202 may be implemented using any other suitable model (e.g., any suitable negative binomial distribution (NBD) model, any suitable regression model, etc.).

The example audience duplication suppressor 102 is provided with the example rate determiner 204 to determine cookie deletion rates. In the illustrated example, cookie deletion rates are representative of the rate at which web browser cookies are deleted at client computers (e.g., the client computers 106 of FIG. 1). In the illustrated example, the rate determiner 204 is used to determine cookie deletion rates for different durations. For example, the rate determiner 204 may determine a daily cookie deletion rate (e.g., a rate at which cookies are deleted at one or more client computers in a day), a multi-day deletion rate (e.g., a rate at which cookies are deleted at one or more client computers over multiple days), a weekly deletion rate (e.g., a rate at which cookies are deleted at one or more client computers over a week), a multi-week deletion rate (e.g., a rate at which cookies are deleted at one or more client computers over multiple weeks), a monthly deletion rate, a multi-month deletion rate, a yearly deletion rate, etc.

The example audience duplication suppressor 102 is provided with the example adjuster 206 to adjust unique web browser reach measures having audience duplication to determine adjusted internet media audience reach measures having suppressed audience duplication (e.g., reach having decreased or eliminated audience duplication effects). In the illustrated example, a unique web browser reach measure with audience duplication is a reach measure derived from the impression data logged in the server-collected internet media impressions database 104. As described above, a unique web browser is represented by a unique cookie identifier logged in the impressions database 104, and the unique web browser is a proxy or surrogate for a unique person. Thus, the unique web browser reach measure with audience duplication is a measure of internet media audience reach that is overestimated due to the effects of audience duplication resulting from deleted cookies at client computers 106 (FIG. 1). In the illustrated example, the adjuster 206 adjusts the unique web browser reach measures having audience duplication based on cookie deletion rates determined by the rate determiner 204.

In the illustrated example, the audience duplication suppressor 102 stores adjusted internet media audience reach measures having suppressed audience duplication in the adjusted reach database 108 of FIG. 1. Operations of the example audience duplication suppressor 102 are described below in connection with the flow diagrams of FIGS. 3 and 4.

FIG. 3 is a flow diagram representative of an example method to determine the internet media audience reach having suppressed audience duplication of FIGS. 1 and 2. FIG. 4 is a flow diagram representative of an example method to determine unique web browser reach using cookie deletion rates and a probability model. In these examples, the machine readable instructions comprise one or more programs for execution by a processor such as the processor 512 shown in the example processor platform 500 discussed below in connection with FIG. 5. The program(s) may be embodied in software stored on a tangible computer readable storage medium such as a CD-ROM, a floppy disk, a hard drive, a digital versatile disk (DVD), a Blu-ray disk, or a memory associated with the processor 512, but the entire program(s) and/or parts thereof could alternatively be executed by a device other than the processor 512 and/or embodied in firmware or dedicated hardware. Further, although the example program(s) is/are described with reference to the flow diagrams illustrated in FIGS. 3 and 4, many other methods of implementing the example audience duplication suppressor 102 may alternatively be used. For example, the order of execution of the blocks may be changed, and/or some of the blocks described may be changed, eliminated, or combined.

As mentioned above, the example processes of FIGS. 3 and 4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 3 and 4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disc and to exclude propagating signals. As used herein, when the phrase “at least” is used as the transition term in a preamble of a claim, it is open-ended in the same manner as the term “comprising” is open ended.

Turning to FIG. 3, initially, the audience duplication suppressor 102 retrieves internet media impression data (block 302), for example, from the server-collected internet media impressions database 104 of FIG. 1. As discussed above, the internet media impression data in the server-collected internet media impressions database 104 exhibits audience duplication. The audience duplication suppressor 102 then selects first and second durations of internet media impression collection (block 304). For example, the audience duplication suppressor 102 may determine audience reach based on a daily period and a weekly period, or based on a daily period and a multi-week period, and/or based on any other time spans. In any case, the durations or time spans define periods during which impression data is collected. If a daily duration is used, then impressions collected during 24-hour periods are used. If a multi-week duration is used, then impressions collected during the selected number of weeks are used.

The audience duplication suppressor 102 then determines an initial average unique web browser reach for the first duration (R_{UB1}) (block 306). In the illustrated example, the initial average unique web browser reach for the first duration (R_{UB1}) represents a quantity of unique persons that have been exposed during the first duration to one or more internet media (e.g., a website, a group of websites, an advertisement campaign, audio media, video media, etc.) for which reach is to be determined. In the illustrated example, the initial average unique web browser reach for the first duration (R_{UB1}) is a percentage or subset of a universe audience. A universe audience in the illustrated example is regarded as a population of persons in a geographic area (e.g., a city, a state, a country, etc.) that have internet access. Thus, the initial average unique web browser reach for the first duration (R_{UB1}) of block 305 is a subset of those persons having internet access, and the subset is selected based on an estimated percentage of those persons that likely were exposed to the internet media of interest during the first duration. The initial average unique web browser reach for the first duration (R_{UB1}) of the illustrated example can be determined based on the impression data in the server-collected internet media impressions database 104 of FIG. 1 (e.g., based on how many impressions of internet media of interest logged over the first duration (D1) correspond to a particular geographic area of interest). Although the initial average of block 306 is for unique web browsers as a proxy for unique persons, because the average is based on the data in the server-collected internet media impressions database 104, the average of block 306 includes the effects of audience duplication due to cookie deletion as described above such that not all unique web browsers in the average of block 306 are actually unique.

The audience duplication suppressor 102 determines an initial average internet media impressions-per-user frequency for the first duration (F_{V1}) (block 308). In the illustrated example, the initial average internet media impressions-per-user frequency for the first duration (F_{V1}) represents the number of times that each person of the initial average unique web browser reach for the first duration (R_{UB1}) accessed particular internet media (for which reach is being calculated) during the first duration. For example, if people visit the same website twice on average during the first duration, the initial average unique web browser reach for the first duration (R_{UB1}) is two. The initial average internet media impressions-per-user frequency for the first duration (F_{V1}) of the illustrated example can be determined based on the impression data in the server-collected internet media impressions database 104 of FIG. 1 (e.g., based on multiple impressions of internet media of interest logged over the first duration (D1) for the same cookie identifier).

The audience duplication suppressor 102 determines an initial average unique web browser reach for the second duration (R_{UB2}) (block 310). In the illustrated example, the initial average unique web browser reach for the second duration (R_{UB2}) represents a quantity of unique persons that have been exposed during the second duration to one or more internet media (e.g., a website, a group of websites, an advertisement campaign, audio media, video media, etc.) for which reach is to be determined. The initial average unique web browser reach for the second duration (R_{UB2}) of the illustrated example can be determined based on the impression data in the server-collected internet media impressions database 104 of FIG. 1 (e.g., based on how many impressions of internet media of interest logged over the second duration (D2) correspond to a particular geographic area of interest).

The audience duplication suppressor 102 determines an initial average internet media impressions-per-user frequency for the second duration (F_{V2}) (block 312). In the illustrated example, the initial average internet media impressions-per-user frequency for the second duration (F_{V2}) represents the number of times that each person of the initial average unique web browser reach for the second duration (R_{UB1}) accessed particular internet media (for which reach is being calculated) during the second duration. The initial average internet media impressions-per-user frequency for the second duration (F_{V2}) of the illustrated example can be determined based on the impression data in the server-collected internet media impressions database 104 of FIG. 1 (e.g., based on multiple impressions of internet media of interest logged over the second duration (D2) for the same cookie identifier).

The audience duplication suppressor 102 determines an adjusted unique web browser reach using a cookie deletion rate and a probability model (block 314). In the illustrated example, the audience duplication suppressor 102 uses the reach and frequency values of blocks 306, 308, 310, and 312 to suppress the effects of audience duplication in the internet media impression data of block 302. In this manner, the audience duplication suppressor 102 determines the adjusted unique web browser reach of block 314 with suppressed (e.g., decreased or eliminated) audience duplication such that the adjusted unique web browser reach of block 314 is more similar than the impression data of block 302 to an actual unique web browser reach uncontaminated by audience duplication that results from cookie deletions at client computers (e.g., the client computers 106 of FIG. 1). An example method that may be used to implement block 314 is described below in connection with FIG. 4.

The audience duplication suppressor 102 stores an adjusted internet media audience reach (block 316) in, for example, the adjusted reach database 108 of FIG. 1. In the illustrated example, the adjusted internet media audience reach of block 316 has suppressed (e.g., decreased or eliminated) audience duplication. In the illustrated example, the audience duplication suppressor 102 sets the adjusted internet media audience reach of block 316 equal to the adjusted unique web browser reach of block 314, because a unique web browser is a proxy for a unique person. Thus, the adjusted unique web browser reach of block 314 is representative of the adjusted internet media audience reach for a population of people. In the illustrated example, the adjusted internet media audience reach is more similar than the impression data of block 302 to an actual internet media audience reach uncontaminated by audience duplication that results from cookie deletions at client computers (e.g., the client computers 106 of FIG. 1). The example method of FIG. 3 ends.

Turning to FIG. 4, the illustrated example method may be used to implement block 314 of FIG. 3 to determine an adjusted unique web browser reach based on a cookie deletion rate and a probability model. The example method of FIG. 4 is described below in connection with the audience duplication suppressor 102 of FIG. 2. In FIG. 4, initially, the probability model 202 (FIG. 2) generates first probability model parameters (a₁,k₁) 208 (block 402). For example, the probability model 202 performs a probability analysis prob(R_{UB1}, F_{V1}, D1) on inputs (R_{UB1}, F_{V1}, D1) 210 including the initial average unique web browser reach for the first duration (R_{UB1}) (e.g., from block 306 of FIG. 3), the initial average internet media impressions-per-user frequency for the first duration (F_{V1}) (e.g., from block 308 of FIG. 3), and a first duration D1 (e.g., selected at block 304 of FIG. 3). For example, if the first duration is a day such that the initial average unique web browser reach for the first duration (R_{UB1}) is a daily average unique web browser reach, the initial average internet media impressions-per-user frequency for the first duration (F_{V1}) is a daily average internet media impressions-per-user frequency. Any other time span may be used for the first duration D1. In the illustrated example, the probability model 202 used for the example method of FIG. 4 is a Gamma Poisson model. However, any other suitable model may be used.

The probability model 202 determines an intermediate estimate of unique web browser reach for a second duration (IR_{UB2}) 212 of FIG. 2 (block 404). For example, to determine the intermediate estimate of unique web browser reach for a second duration (IR_{UB2}) 212, the probability model 202 performs a probability analysis prob(a₁,k₁,D2) on inputs (a₁,k₁,D2) 214 including the probability model parameters (a₁,k₁) determined at block 402, and a second duration D2 (e.g., selected at block 304 of FIG. 3). In the illustrated example, the second duration (D2) is longer than the first duration (D1).

The rate determiner 204 (FIG. 2) determines a cookie deletion rate for the second duration (DELETION_RATE₂) 216 of FIG. 2 (block 406). In the illustrated example, the rate determiner 204 determines the cookie deletion rate for the second duration (DELETION_RATE₂) 216 based on the intermediate estimate of unique web browser reach for a second duration (IR_{UB2}) 212 determined at block 406 and the initial average unique web browser reach for the second duration (R_{UB2}) (e.g., from block 310 of FIG. 3). For example, the rate determiner 204 may determine the cookie deletion rate for the second duration (DELETION_RATE₂) 216 using the Equation 1 below.

DELETION_RATE₂=100×(R_{UB2}−IR_{UB2})/(R_{UB2}). Equation 1

In the illustrated example, the cookie deletion rate for the second duration (DELETION_RATE₂) 216 of Equation 1 is represented as a percentage.

The rate determiner 204 then determines a cookie deletion rate for the first duration (DELETION_RATE₁) 220 of FIG. 2 (block 408). In the illustrated example, the rate determiner 204 determines the cookie deletion rate for the first duration (DELETION_RATE₁) 220 based on the cookie deletion rate for the second duration (DELETION_RATE₂) 216 determined at block 406 and the second duration D2. For example, the rate determiner 204 may determine the cookie deletion rate for the first duration (DELETION_RATE₁) 220 using the Equation 2 below.

DELETION_RATE₁=100×[(100+DELETION_RATE₂)^{1/D2}−1]. Equation 2

In the illustrated example, the cookie deletion rates (DELETION_RATE₂) 216 and (DELETION_RATE₁) 220 of Equation 2 are represented as percentages, and the second duration (D2) of Equation 2 is represented in days.

The adjuster 206 (FIG. 2) determines an adjusted unique web browser reach with suppressed audience duplication for the first duration (AR_{UB1}) 222 of FIG. 2 (block 410). For example, to determine the adjusted unique web browser reach with suppressed audience duplication for the first duration (AR_{UB1}) 222, the adjuster 206 receives inputs (R_{UB1},DELETION_RATE₁) 224 and adjusts the initial average unique web browser reach for the first duration (R_{UB1}) (e.g., from block 306 of FIG. 3) based on the cookie deletion rate for the first duration (DELETION_RATE₁) 220 determined at block 408. For example, the adjuster 206 may determine the adjusted unique web browser reach with suppressed audience duplication for the first duration (AR_{UB1}) 222 using Equation 3 below.

AR_{UB1}=R_{UB1}×(100−DELETION_RATE₁)/100 Equation 3

In the illustrated example, the cookie deletion rate for the first duration (DELETION_RATE₁) 220 of Equation 3 is represented as a percentage. In the illustrated example, the adjusted unique web browser reach with suppressed audience duplication for the first duration (AR_{UB1}) 222 has relatively less audience duplication than the initial average unique web browser reach for the first duration (RUM (e.g., from block 306 of FIG. 3).

The probability model 202 generates second probability model parameters (a₂,k₂) 226 (block 412). For example, the probability model 202 performs a probability analysis prob(AR_{UB1}, F_{V1}, D1) on inputs (AR_{UB1}, F_{V1}, D1) 228 including the internet media audience reach with suppressed audience duplication (AR_{UB1}) 222 from block 410, the initial average internet media impressions-per-user frequency for the first duration (F_{V1}) (e.g., from block 308 of FIG. 3), and the first duration D1 (e.g., selected at block 304 of FIG. 3).

The probability model 202 determines an adjusted unique web browser reach with suppressed audience duplication for the second duration (AR_{UB2}) 230 of FIG. 2 (block 414). For example, to determine the adjusted unique web browser reach with suppressed audience duplication for the second duration (AR_{UB2}) 230, the probability model 202 performs a probability analysis prob(a₂,k₂,D2) on inputs (a₂,k₂,D2) 232 including the second probability model parameters (a₂,k₂) determined at block 412, and the second duration D2. In the illustrated example, the adjusted unique web browser reach with suppressed audience duplication for the second duration (AR_{UB2}) 230 has relatively less audience duplication than the initial average unique web browser reach for the second duration (R_{UB2}) (e.g., from block 310 of FIG. 3). The example process of FIG. 4 then ends.

As discussed above in connection with block 316 of FIG. 3, the audience duplication suppressor 102 can set an adjusted internet media audience reach equal to an adjusted unique web browser reach determined using the example method of FIG. 4. In some examples, the audience duplication suppressor 102 sets the adjusted internet media audience reach equal to the adjusted unique web browser reach with suppressed audience duplication for the first duration (AR_{UB1}) 222. In some examples, the audience duplication suppressor 102 sets the adjusted internet media audience reach equal to the adjusted unique web browser reach with suppressed audience duplication for the second duration (AR_{UB2}) 230. In yet other examples, the audience duplication suppressor 102 sets a first adjusted internet media audience reach equal to the adjusted unique web browser reach with suppressed audience duplication for the first duration (AR_{UB1}) 222, and sets a second adjusted internet media audience reach equal to the adjusted unique web browser reach with suppressed audience duplication for the second duration (AR_{UB2}) 230. In any case, the audience duplication suppressor 102 stores the adjusted internet media audience reach measure(s) in, for example, the adjusted reach database 108 of FIG. 1 as a measure or measures of internet media audience reach with suppressed audience duplication.

An example use of the example methods of FIGS. 3 and 4 is as follows based on a first and second durations D1 and D2 selected at block 304 of FIG. 3 to be D1=one day and D2=28 days (e.g., four weeks); an initial average unique web browser reach for the first duration (R_{UB1}) determined at block 306 of FIG. 3 to be 2% (i.e., R_{UB1}=2%), an initial average internet media impressions-per-user frequency for the first duration (F_{V1}) selected at block 308 of FIG. 3 to be two (i.e., F_{V1}=2); an initial average unique web browser reach for the second duration (R_{UB2}) determined at block 310 of FIG. 3 to be 10% (i.e., R_{UB2}=10%); and an initial average internet media impressions-per-user frequency for the second duration (F_{V2}) determined at block 312 of FIG. 3 to be 11.2 (i.e., F_{V2}=11.2). In such an example, the probability model 202 of FIG. 2 determines the first probability model parameters (a₁,k₁) at block 402 of FIG. 4 as Gamma Poisson model parameters a₁=2.454 and k₁=0.0163. The probability model 202 then uses the first probability model parameters (a₁,k₁) to determine the intermediate estimate of unique web browser reach for a second duration (IR_{UB2}) 212 of FIG. 2 to be 6.7% (i.e., IR_{UB2}=6.7%) at block 404 of FIG. 4. The rate determiner 204 of FIG. 2 then determines the cookie deletion rate for the second duration (DELETION_RATE₂) 216 of FIG. 2 to be 33% (i.e., DELETION_RATE₂=33%) at block 406 of FIG. 4 using Equation 1 above (100×(10−6.7)/10=33%).

The rate determiner 204 then determines the cookie deletion rate for the first duration (DELETION_RATE₁) 220 of FIG. 2 to be 1.02% (i.e., DELETION_RATE₁=1.02%) at block 408 of FIG. 4 using Equation 2 above (100×[(1.33)¹²⁸−1]=1.02%). The adjuster 206 of FIG. 2 then determines the adjusted unique web browser reach with suppressed audience duplication for the first duration (AR_{UB1}) 222 of FIG. 2 to be 1.9796% (i.e., AR_{UB1}=1.9796%) at block 410 using Equation 3 above (2%×(100−1.02)/100=1.9796%). In the illustrated example, the adjusted unique web browser reach with suppressed audience duplication for the first duration (AR_{UB1}) 222 represents a 1.9796% daily internet media audience reach with suppressed audience duplication. The 1.9796% reach is a daily reach of a universe audience (e.g., a population of persons having internet access in a geographic area such as a city, a state, a country, etc.). In the illustrated example, the audience duplication suppressor 102 can store the 1.9796% daily internet media audience reach with suppressed audience duplication in the adjusted reach database 108 of FIG. 1

The probability model 202 of FIG. 2 then determines the second probability model parameters (a₂,k₂) at block 412 of FIG. 4 as Gamma Poisson model parameters a₁=2.514 and k₁=0.0159. The probability model 202 then uses the second probability model parameters (a₂,k₂) to determine the adjusted unique web browser reach with suppressed audience duplication for the second duration (AR_{UB2}) 230 of FIG. 2 to be 6.56% (i.e., AR_{UB2}=6.56%) at block 414 of FIG. 4. In the illustrated example, the adjusted unique web browser reach with suppressed audience duplication for the second duration (AR_{UB2}) 230 represents a 6.56% 28-day internet media audience reach with suppressed audience duplication. The 6.56% reach is a 28-day reach of a universe audience (e.g., a population of persons having internet access in a geographic area such as a city, a state, a country, etc.). In the illustrated example, the audience duplication suppressor 102 can store the 6.56% 28-day internet media audience reach with suppressed audience duplication in the adjusted reach database 108 of FIG. 1.

FIG. 5 is a block diagram of an example processor platform 500 capable of executing the instructions of FIGS. 3 and 4 to implement examples disclosed herein. The processor platform 500 can be, for example, a server, a personal computer, an Internet appliance, or any other type of computing device.

The processor platform 500 of the illustrated example includes a processor 512. The processor 512 of the illustrated example is hardware. For example, the processor 512 can be implemented by one or more integrated circuits, logic circuits, microprocessors or controllers from any desired family or manufacturer.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), and/or a PCI express interface.

In the illustrated example, one or more input devices 522 are connected to the interface circuit 520. The input device(s) 522 permit(s) a user to enter data and commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 520 of the illustrated example, thus, typically includes a graphics driver card, a graphics driver chip or a graphics driver processor.

The interface circuit 520 of the illustrated example also includes a communication device such as a transmitter, a receiver, a transceiver, a modem and/or network interface card to facilitate exchange of data with external machines (e.g., computing devices of any kind) via a network 526 (e.g., an Ethernet connection, a digital subscriber line (DSL), a telephone line, coaxial cable, a cellular telephone system, etc.).

The processor platform 500 of the illustrated example also includes one or more mass storage devices 528 for storing software and/or data. Examples of such mass storage devices 528 include floppy disk drives, hard drive disks, compact disk drives, Blu-ray disk drives, RAID systems, and digital versatile disk (DVD) drives.

Instructions of FIGS. 3 and 4 may be stored as coded instructions 532 in the mass storage device 528, in the volatile memory 514, in the non-volatile memory 516, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to determine internet media audience reach, the method comprising:
accessing an initial average unique web browser reach corresponding to a first duration, an initial average internet media impressions-per-user frequency corresponding to the first duration, an initial average unique web browser reach corresponding to a second duration, and an initial average internet media impressions-per-user frequency corresponding to the second duration; and
using a probability model with a processor to determine an adjusted internet media audience reach corresponding to the first duration based on the initial average unique web browser reach corresponding to the first duration, the initial average internet media impressions-per-user frequency corresponding to the first duration, the initial average unique web browser reach corresponding to the second duration, and the initial average impressions-per-user frequency corresponding to the second duration, wherein the adjusted internet media audience reach corresponding to the first duration has less audience duplication than the initial average unique web browser reach corresponding to the first duration.

2. A method as defined in claim 1, wherein using the probability model to determine the adjusted internet media audience reach corresponding to the first duration comprises using the probability model to determine first probability model parameters based on the first duration, the initial average unique web browser reach corresponding to the first duration, and the initial average internet media impressions-per-user frequency corresponding to the first duration.

3. A method as defined in claim 2, further comprising using the probability model to determine an adjusted internet media audience reach corresponding to the second duration based on second probability model parameters determined by the probability model, the adjusted internet media audience reach corresponding to the second duration having less audience duplication than the initial average unique web browser reach corresponding to the second duration.

4. A method as defined in claim 1, wherein the internet media is at least one of a website, a media stream, or an advertisement.

5. A method as defined in claim 1, wherein the initial average unique web browser reach corresponding to the first duration and the initial average unique web browser reach corresponding to the second duration are subsets of a universe audience of persons having internet access.

6. A method as defined in claim 1, further comprising determining the adjusted internet media audience reach corresponding to the first duration based on a cookie deletion rate corresponding to the first duration and a cookie deletion rate corresponding to the second duration, wherein the cookie deletion rates are representative of rates at which web browser cookies are deleted at client computers during the first and second durations.

7. A method as defined in claim 1, wherein the probability model is a Gamma Poisson model.

8. An apparatus comprising:
a hardware processor to execute a probability model to determine an intermediate unique web browser reach corresponding to a second duration based on first probability model parameters corresponding to a first duration;
a rate determiner to:
determine a cookie deletion rate corresponding to the second duration based on the intermediate unique web browser reach corresponding to the second duration, and
determine a cookie deletion rate corresponding to the first duration based on the cookie deletion rate corresponding to the second duration;
an adjuster to determine an adjusted unique web browser reach corresponding to the first duration by using the cookie deletion rate corresponding to the first duration to adjust an average unique web browser reach corresponding to the first duration having audience duplication; and
the probability model to:
determine second probability model parameters based on the adjusted unique web browser reach corresponding to the first duration, and
determine an adjusted internet media audience reach corresponding to the second duration based on the second probability model parameters, the adjusted internet media audience reach corresponding to the second duration having less audience duplication than server-collected internet media impression data associated with internet media presented via a plurality of client computers.

9. An apparatus as defined in claim 8, wherein the cookie deletion rates corresponding to the first and second durations are representative of rates at which web browser cookies are deleted at client computers during the first and second durations.

10. An apparatus as defined in claim 8, wherein the first probability model parameters corresponding to the first duration are based on the first duration, an initial average unique web browser reach corresponding to the first duration, and an initial average internet media impressions-per-user frequency corresponding to the first duration, wherein the initial average unique web browser reach corresponding to the first duration and the initial average internet media impressions-per-user frequency corresponding to the first duration are based on the server-collected internet media impression data.

11. An apparatus as defined in claim 10, wherein the initial average unique web browser reach corresponding to the first duration is a subset of a universe audience of persons having internet access.

12. An apparatus as defined in claim 8, wherein the internet media is at least one of a website, a media stream, or an advertisement.

13. An apparatus as defined in claim 8, wherein the probability model comprises a Gamma Poisson model.

14. A tangible computer readable storage medium comprising instructions that, when executed, cause a machine to at least:
access an initial average unique web browser reach corresponding to a first duration, an initial average internet media impressions-per-user frequency corresponding to the first duration, an initial average unique web browser reach corresponding to a second duration, and an initial average internet media impressions-per-user frequency corresponding to the second duration; and
use a probability model to determine an adjusted internet media audience reach corresponding to the first duration based on the initial average unique web browser reach corresponding to the first duration, the initial average internet media impressions-per-user frequency corresponding to the first duration, the initial average unique web browser reach corresponding to the second duration, and the initial average impressions-per-user frequency corresponding to the second duration, wherein the adjusted internet media audience reach corresponding to the first duration has less audience duplication than the initial average unique web browser reach corresponding to the first duration.

15. A computer readable storage medium as defined in claim 14, wherein the instructions further cause the machine to:
determine first probability model parameters based on the first duration, the initial average unique web browser reach corresponding to the first duration, and the initial average internet media impressions-per-user frequency corresponding to the first duration; and
determine the adjusted internet media audience reach corresponding to the first duration based on the first probability model parameters.

16. A computer readable storage medium as defined in claim 15, wherein the instructions further cause the machine to:
use the probability model to determine second probability model parameters; and
determine an adjusted internet media audience reach corresponding to the second duration based on the second probability model parameters, the adjusted internet media audience reach corresponding to the second duration having less audience duplication than the initial average unique web browser reach corresponding to the second duration.

17. A computer readable storage medium as defined in claim 14, wherein the internet media is at least one of a website, a media stream, or an advertisement.

18. A computer readable storage medium as defined in claim 14, wherein the initial average unique web browser reach corresponding to the first duration and the initial average unique web browser reach corresponding to the second duration are subsets of a universe audience of persons having internet access.

19. A computer readable storage medium as defined in claim 14, wherein the instructions further cause the machine to determine the adjusted internet media audience reach corresponding to the first duration based on a cookie deletion rate corresponding to the first duration and a cookie deletion rate corresponding to the second duration, wherein the cookie deletion rates are representative of rates at which web browser cookies are deleted at client computers during the first and second durations.

20. A computer readable storage medium as defined in claim 14, wherein the probability model is a Gamma Poisson model.
